(19) United States
(12) Patent Application Publication
(10) Pub. No.: US 2007/0065800 A1
(43) Pub. Date: Mar. 22, 2007

(54) Display apparatus and video wall having the same

(75) Inventors: Jung-Yi Yang, Taoyuan Hsien (TW); Chao-Ching Ho, Taoyuan Hsien (TW)

Correspondence Address: LADAS & PARRY, 26 WEST 61ST STREET, NEW YORK, NY, 10023, US

(73) Assignee: DELTA ELECTRONICS, INC.

(21) Appl. No.: 11/230,103

(22) Filed: Sep. 19, 2005

(51) Int. Cl. G09B 25/00

(52) U.S. Cl. 434/428; 345/156

(57) ABSTRACT

A display apparatus and a video wall having the same and, more particularly, a display apparatus using a differential digital signal transmitted to a display apparatus in a next stage for display are provided. The display apparatus and the video wall provide a data enable signal, which is required by the differential digital signal transmission, to solve the problem of being unable to provide the data enable signal for most of the conventional A/D converters employed for the video display applications. Only one scaler instead of two scalers is used to solve the moving picture artifact due to delay. A de-interlacer is used to improve the display quality and to maintain a color space of the transmitted video signal in an RGB format.

### BACKGROUND OF THE INVENTION

1. Field of the Invention

The present invention relates to a display apparatus and a video wall having the same; in particular, relates to a display apparatus transmitting a video signal via a differential digital signal toward a display apparatus of a next stage and a video wall having this display apparatus.

2. Descriptions of the Related Art

Video walls have been applied popularly in large exhibitions and in public places for the need of large-sized displays in recent years. A video wall combines a plurality of display apparatuses each of which selects one corresponding part of a displayed picture according to its position in the video wall and enlarges the part to display on a whole screen of the display apparatus. All of the plurality of display apparatuses then together display the displayed picture carried by a video signal.

Because the video wall uses the plurality of display apparatuses to display one picture, two adjacent display apparatuses are generally connected via a computer digital video interface, such as DVI connectors, to transmit the video signal outputted from a video source in a digital format. However, such a transmission in the digital format needs a data enable signal. To generate the data enable signal, the circuitry of conventional display apparatuses applied in video walls is very complicated.

FIG. 1 shows an application of a conventional video wall, wherein the application comprises a video source 100 and a plurality of identical display apparatuses 110, 120, 130, and 140. The video source 100 outputs video signals including an analog RGB signal, a transition minimized differential signaling (TMDS) signal and a video signal. The video wall includes the four display apparatuses 110, 120, 130, and 140 in this application. The display apparatus 110 selects one of the video signals inputted into an input module 113 and displays a part of a displayed picture according to the selected video signal provided by the video source 100. The selected video signal is then transmitted to an input module 123 of the display apparatus 120 in a differential digital format through a TMDS output 115. The display apparatus 120 displays another part of the displayed picture according to the received video signal in the differential digital format. The received video signal in the differential digital format is then transmitted to the display apparatus 130 of a next stage through a TMDS output 125.

Similarly, the display apparatus 130 displays still another part of the displayed picture according to the received video signal in the differential digital format. The received video signal is then transmitted to the display apparatus 140 of a next stage. The four display apparatuses of the video wall hence receive the video signal outputted from the video source 100. According to its arranged position in the video wall, each of the display apparatuses chooses a corresponding part of the displayed picture (¼ of the displayed picture in this application) and enlarges the part to display on the screen of the display apparatus. As a jigsaw puzzle, the four parts of the displayed picture each of which is displayed by one corresponding display apparatus combine into the displayed picture carried by the video signal transmitted from the video source 100. The displayed picture is enlarged four times greater than the original one thereby.

A circuitry of the display apparatus of the prior art is illustrated in FIG. 2, wherein the display apparatus comprises an A/D (analog-to-digital) converter 210, a differential digital signal (DS) receiver 220, a video decoder 230, a selection switch 235, a first scaler 240, a differential digital signal (DS) transmitter 250, and a second scaler 260.

The A/D converter 210, the DS receiver 220, and the video decoder 230 receive an analog RGB signal from a computer, a differential digital signal, and a video signal respectively. The selection switch 235 is configured to select one of synchronous signals outputted from the A/D converter 210 and the DS receiver 220. Each of the synchronous signals comprises a pixel clock signal CLK, a horizontal synchronizing signal H-Sync, and a vertical synchronizing signal V-Sync. The synchronous signal outputted from the DS receiver 220 further comprises a data enable signal DE. The selection switch 235 selects one of the two synchronous signals. The synchronous signal selected by the selection switch 235 as well as the digital RGB (display) signals transmitted from the AID converter 210 and the DS receiver 220 are transmitted to a graphics port 242 of the first scaler 240. The synchronous signal and the digitized YUV (display) signal outputted from the video decoder 230 are transmitted to a video port 244 of the first scaler 240 directly.

The first scaler 240 is configured to selectively process the input signal from either the graphics port 242 or the video port 244 and then to re-generate an output video signal, including the synchronous signal and the display signal, transmitted from a display port 246 to the DS transmitter 250 and the second scaler 260. The DS transmitter 250 transmits the output video signal to the display apparatus of a next stage. The second scaler 260 selects the corresponding part to display according to the position of the display apparatus and enlarges the corresponding part to display on a display device (not illustrated) of the display apparatus.

As FIG. 2 shows, the display apparatus of the prior art comprises two scalers, wherein the scalers herein are called scan converters in some documents. In practical circuit design, either one or both of the two scalers are sometimes replaced by field programmable gate arrays (FPGAs). The functions of the scalers, the scan converters, and the FPGAs are similar in such an application. The functions of the scalers involve at least image scaling and/or frame rate conversion. The video signal in a differential signaling format received by the DS receiver 220 or transmitted by the DS transmitter 250 may be a TMDS signal or a low voltage differential signaling (LVDS) signal. Besides, the DS receiver 220 and DS transmitter 250 should be selected in accordance with the type of the differential signal employed in the video transmission between two adjacent display apparatuses. No matter TMDS or LVDS is used, the DS transmitter 250 needs to receive a data enable signal for properly functioning.

However, the outputted synchronous signals of most of the A/D converters used for video display applications in the market, such as AD9884 of Analog Device Inc., ICS1531 of Integrated Circuit System Inc., or TDA8752 of Philips, do not include a data enable signal as the A/D converter 210 shows. The other circuits, e.g., the DS receiver 220 and the video decoder 230 are able to output a data enable signal. Because the synchronous signal outputted from the A/D converter 210 does not include a data enable signal, the first scaler 240 is used to process the synchronous signal outputted from the A/D converter 210 so that the re-generated synchronous signal outputted from the display port 246 includes a data enable signal.

The circuitry of the display apparatus in FIG. 2 involves a complicated design because there are two scalers in this application requiring controlled and set. In general, the video format outputted from the display port 246 is configured with a fixed resolution, such as 1024×768 pixels. For an input video having a higher resolution, such as 1280×1024 pixels, the displayed picture would be compressed by the first scaler 240 and then transmitted to the next display apparatus. Therefore, after processed by the first scaler 240, the resolution of the displayed picture received by all of the following display apparatuses is 1024×768 instead of 1280×1024. The display quality is sacrificed.

Another drawback of the display apparatus in FIG. 2 is that there is a delay time generated by the first scaler 240 when the first scaler 240 processes the inputted video signal. Since the displayed picture is combined by all parts displayed by the display apparatuses which are connected in series, an artifact of the displayed moving picture resulting from the delay time is significant.

Because of the above problems, the present invention discloses a new circuitry to simplify the structure of conventional display apparatuses and to solve the aforementioned drawbacks.

### SUMMARY OF THE INVENTION

The present invention provides a display apparatus and a video wall having the display apparatus. The aforementioned drawback that the synchronous signal outputted from an A/D converter does not comprise a data enable signal can be solved by adding a data enable signal generator into the display apparatus of the present invention. Besides, the present invention does not need an additional scaler like the first scaler 240 in FIG. 2 so it avoids that the resolution degraded after processed by the additional scaler becomes a compressed but not original resolution. Therefore, the display quality would not be affected, and the delay time is eliminated. In other words, the moving picture artifact due to the delay time is solved.

In one embodiment, a de-interlacer is added to improve the display quality and to maintain a color space of the transmitted video signal in an RGB format.

In the above embodiment, every element of the display apparatus is controlled by a microcontroller. The microcontroller is coupled to a memory which stores the detailed data of each synchronization timing. For an analog RGB signal inputted by computers, when its timing format is determined, the microcontroller reads the detailed data of the corresponding synchronization timing from the memory to control operations of each element, including to control the data enable signal generator to generate a data enable signal.

The present invention also provides the following elements. An A/D converter is configured to receive an analog RGB signal and to output a first display signal and a first synchronous signal. A differential digital signal receiver is configured to receive a differential digital signal and to output a second display signal and a second synchronous signal. A data enable signal generator, connected to the A/D converter, is configured to receive the first synchronous signal from the A/D converter and to output a third synchronous signal having a data enable signal. A selection switch, having an input end electrically connected to the data enable signal generator and the differential digital signal receiver, is configured to select one of the second synchronous signal and the third synchronous signal and to output a fourth synchronous signal. A differential digital signal transmitter is configured to transmit the fourth synchronous signal and to selectively transmit one of the first display signal and the second display signal. A scaler is configured to receive the fourth synchronous signal and to selectively receive one of the first display signal and the second display signal as a basis for a picture displayed on the display apparatus.

The aforementioned display apparatus further comprises a video decoder for receiving a video signal and for outputting a third display signal and a fifth synchronous signal, wherein the fifth synchronous signal is transmitted to the selection switch, and the selection switch outputs the fourth synchronous signal according to one of the second synchronous signal, the third synchronous signal, and the fifth synchronous signal. In such an embodiment, the differential digital signal transmitter is configured to transmit the fourth synchronous signal and to selectively transmit one of the first display signal, the second display signal and the third display signal based on the fourth synchronous signal. For example, if the fourth synchronous signal is outputted based on the second synchronous signal, then the differential digital signal transmitter transmits the second display signal by disabling the A/D converter and the video decoder. The scaler is configured to receive the fourth synchronous signal and to selectively receive one of the first display signal, the second display signal and the third display signal based on the fourth synchronous signal, as a basis for a picture displayed on the display apparatus.

Alternatively, the aforementioned display apparatus further comprises a video decoder for receiving a video signal and for outputting a digitized video signal; and a de-interlacer, connected to the video decoder, for receiving the digitized video signal and for converting from the digitized video signal into a fourth display signal and a sixth synchronous signal. The sixth synchronous signal is transmitted to the selection switch, and the selection switch outputs the fourth synchronous signal according to one of the second synchronous signal, the third synchronous signal and the sixth synchronous signal. In such an embodiment, the differential digital signal transmitter is configured to transmit the fourth synchronous signal and to selectively transmit one of the first display signal, the second display signal and the fourth display signal based on the fourth synchronous signal. The scaler is configured to receive the fourth synchronous signal and to selectively receive one of the first display signal, the second display signal and the fourth display signal based on the fourth synchronous signal, as a basis for a picture displayed on the display apparatus.

In the aforementioned display apparatus, the de-interlacer converts from the digitized video signal in a first color space into the fourth display signal in a second color space, wherein the digitized video signal in the first color space is an interlaced video signal and the fourth display signal in the second color space is a progressive scan video signal. The first color space is YUV, and the second color space is RGB.

The aforementioned display apparatus further comprises a microcontroller, coupled to the data enable signal generator, for receiving the analog RGB signal and for controlling the data enable signal generator to generate the data enable signal according to a timing format of the analog RGB signal; and a memory coupled to the microcontroller. After the microcontroller receives the analog RGB signal, the microcontroller determines the timing format of the analog RGB signal according to a data stored in the memory and controls the data enable signal generator to generate the data enable signal according to a plurality of timing setting parameters corresponding to the determined timing format stored in the memory.

In the aforementioned display apparatus, the differential digital signal is a TMDS signal or an LVDS signal.

Another object of the present invention is to provide a video wall having a plurality of display apparatuses connected in series. Each of the display apparatuses comprises a differential digital signal receiver and a differential digital signal transmitter. The differential digital signal receiver is configured to receive a differential digital signal transmitted by a display apparatus in a previous stage. The differential digital signal transmitter is configured to transmit the differential digital signal to a display apparatus in a next stage. A display apparatus in a first stage of the plurality of display apparatuses may comprise the aforementioned display apparatus provided by the present invention.

Another object of the present invention is to provide a display apparatus adapted for a video wall. The display apparatus comprises: an A/D converter for receiving an analog RGB signal and for outputting a first display signal and a first synchronous signal having a data enable signal; a differential digital signal receiver for receiving a differential digital signal and for outputting a second display signal and a second synchronous signal; a selection switch, having an input end electrically connected to the A/D converter and the differential digital signal receiver, for selecting one of the first synchronous signal and the second synchronous signal and for outputting a third synchronous signal; a differential digital signal transmitter for transmitting the third synchronous signal and for selectively transmitting one of the first display signal and the second display signal; and a scaler for receiving the third synchronous signal and for selectively receiving one of the first display signal and the second display signal as a basis for a picture displayed on the display apparatus.

The aforementioned display apparatus further comprises a video decoder for receiving a video signal and for outputting a third display signal and a fourth synchronous signal. The fourth synchronous signal is transmitted to the selection switch, and the selection switch outputs the third synchronous signal according to one of the first synchronous signal, the second synchronous signal, and the fourth synchronous signal. In such an embodiment, the differential digital signal transmitter is configured to transmit the third synchronous signal and to selectively transmit one of the first display signal, the second display signal and the third display signal based on the third synchronous signal. The scaler is configured to receive the third synchronous signal and to selectively receive one of the first display signal, the second display signal and the third display signal based on the third synchronous signal, as a basis for a picture displayed on the display apparatus.

Alternatively, the aforementioned display apparatus further comprises a video decoder for receiving a video signal and for outputting a digitized video signal; and a de-interlacer, connected to the video decoder, for receiving the digitized video signal, and for converting from the digitized video signal into a fourth display signal and a fifth synchronous signal. The fifth synchronous signal is transmitted to the selection switch, and the selection switch outputs the third synchronous signal according to one of the first synchronous signal, the second synchronous signal, and the fifth synchronous signal. In such an embodiment, the differential digital signal transmitter is configured to transmit the third synchronous signal and to selectively transmit one of the first display signal, the second display signal and the fourth display signal based on the third synchronous signal. The scaler is configured to receive the third synchronous signal and to selectively receive one of the first display signal, the second display signal and the fourth display signal based on the third synchronous signal, as a basis for a picture displayed on the display apparatus.

In the aforementioned display apparatus, the de-interlacer converts from the digitized video signal in a first color space into the fourth display signal in a second color space. The digitized video signal in the first color space is an interlaced video signal and the fourth display signal in the second color space is a progressive scan video signal. The first color space is YUV and the second color space is RGB.

The aforementioned display apparatus further comprises a microcontroller, coupled to the A/D converter, for receiving the analog RGB signal and for controlling the A/D converter to generate the data enable signal according to a timing format of the analog RGB signal; and a memory coupled to the microcontroller. After the microcontroller receives the analog RGB signal, the microcontroller determines the timing format of the analog RGB signal according to a data stored in the memory and controls the A/D converter to generate the data enable signal according to a plurality of timing setting parameters corresponding to the determined timing format stored in the memory.

In the aforementioned display apparatus, the differential digital signal is a TMDS signal or an LVDS signal.

Another object of the present invention is to provide a video wall having a plurality of display apparatuses. The plurality of display apparatuses are connected in series. Each of the display apparatuses comprises a differential digital signal receiver and a differential digital signal transmitter. The differential digital signal receiver is configured to receive a differential digital signal transmitted by a display apparatus in a previous stage. The differential digital signal transmitter is configured to transmit the differential digital signal to a display apparatus of a next stage of the plurality of display apparatuses. A display apparatus in a first stage may comprise the aforementioned display apparatus provided by the present invention.

The present invention further provides a video conversion apparatus adapted for a display apparatus. More particularly, the video conversion apparatus is adapted for A/D converting and transmitting an analog video to an external display apparatus via a differential digital signal transmission. The video conversion apparatus comprises an A/D converter for receiving an analog RGB signal and for outputting a first display signal and a first synchronous signal; and a data enable signal generator, connected to the A/D converter, for receiving the first synchronous signal and for outputting a second synchronous signal having a data enable signal. The data enable signal generator receives a plurality of timing parameters of a timing format of the analog RGB signal. The data enable signal is generated according to a (pixel) clock signal, a horizontal synchronizing signal, and a vertical synchronizing signal of the first synchronous signal and the plurality of timing parameters of the timing format of the analog RGB signal.

The aforementioned video conversion apparatus further comprises a microcontroller and a memory. The microcontroller, coupled to the data enable signal generator and the memory, is configured to receive the analog RGB signal and to determine the timing format of the analog RGB signal. The microcontroller retrieves the plurality of timing parameters corresponding to the timing format from the memory and transmits the plurality of timing parameters to the data enable signal generator to generate the data enable signal.

In the aforementioned video conversion apparatus, the data enable signal is a composite signal consisting of both a horizontal data enable signal and a vertical data enable signal in a single data enable signal. The horizontal data enable signal is generated according to the clock signal and the horizontal synchronizing signal of the first synchronous signal and a plurality of timing parameters of the horizontal synchronizing signal. The vertical data enable signal is generated from the horizontal data enable signal and a plurality of parameters of the vertical synchronizing signal.

The present invention further provides a video wall having a plurality of display apparatuses, wherein at least one display apparatus has the aforementioned video conversion apparatus to receive an analog RGB signal.

Because of the use of the display apparatus having a video conversion apparatus, the present invention simplifies the complexity of the system, decreases delay time, and does not compress the timing format outputted from a video source so the resolution is not changed.

To make the aforementioned and other objects, features, and advantages of the present invention understood clearly and easily, please refer to the following descriptions as well as the appended figures.

### BRIEF DESCRIPTION OF THE DRAWINGS

FIG. 1 illustrates a simplified application of a video wall of the prior art;

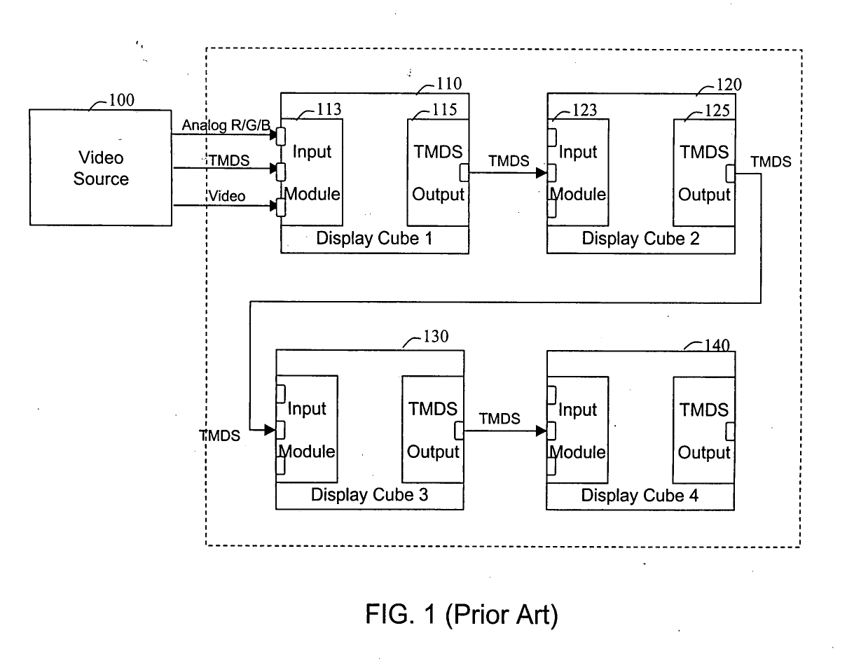

FIG. 2 illustrates a block diagram of a display apparatus of the prior art;

FIG. 3 illustrates a block diagram of an embodiment of a display apparatus in accordance with the present invention;

FIG. 4 illustrates a block diagram of another embodiment of the display apparatus in accordance with the present invention;

FIG. 5 illustrates a block diagram in which a data enable signal generator follows an A/D converter in accordance with the present invention;

FIG. 6 illustrates a timing diagram of a timing signal of the data enable signal generator in accordance with the present invention;

FIG. 7 illustrates a timing diagram including a data enable signal, a horizontal synchronizing signal, and a vertical synchronizing signal; and

FIG. 8 illustrates a flow chart of generation of a data enable signal.

### DESCRIPTION OF THE PREFERRED EMBODIMENT

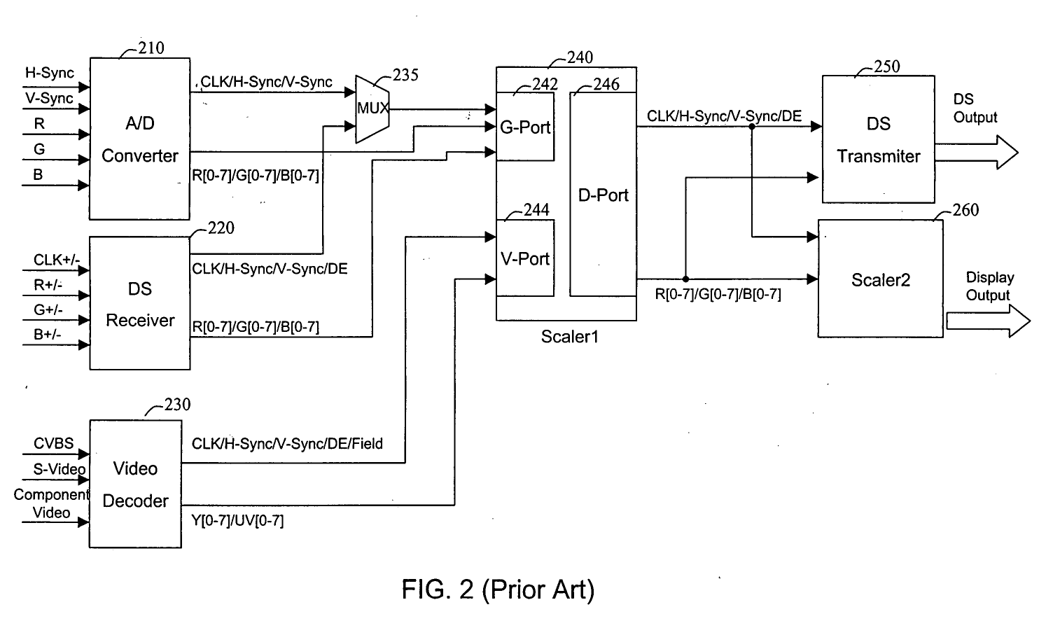

One embodiment of the present invention provides a display apparatus and a video wall having the display apparatus. The display apparatus of this embodiment solves the problem that a synchronous signal outputted from an A/D converter does not include a data enable signal by adding a data enable signal generator. The present invention does not need an additional scaler like the scaler 240 illustrated in FIG. 2. Therefore, the problem that a video signal, after processed by the additional scaler, received by the following display apparatuses is compressed but not original can be avoided so the display quality is not influenced. Besides, the delay time due to the additional scaler is also eliminated so a moving picture artifact due to the delay time is avoided.

In one embodiment, a de-interlacer is included to improve the display quality and to maintain the color space of the video signal in an RGB format during transmission.

In one embodiment of the present invention, the elements included in a display apparatus are controlled by a microcontroller. The microcontroller is coupled to a memory which is configured to store detailed data of each synchronization timing. When a timing format of an analog RGB signal is determined, the microcontroller reads the corresponding detailed data from the memory and controls operations of each element, including controlling the data enable signal generator to generate a data enable signal. In other words, after the microcontroller receives the analog RGB signal, the microcontroller determines the timing format of the analog RGB signal according to the data stored in the memory and controls the data enable signal generator to generate a data enable signal according to a plurality of timing setting parameters corresponding to the determined timing data in the memory.

The following descriptions specify several embodiments of the present invention.

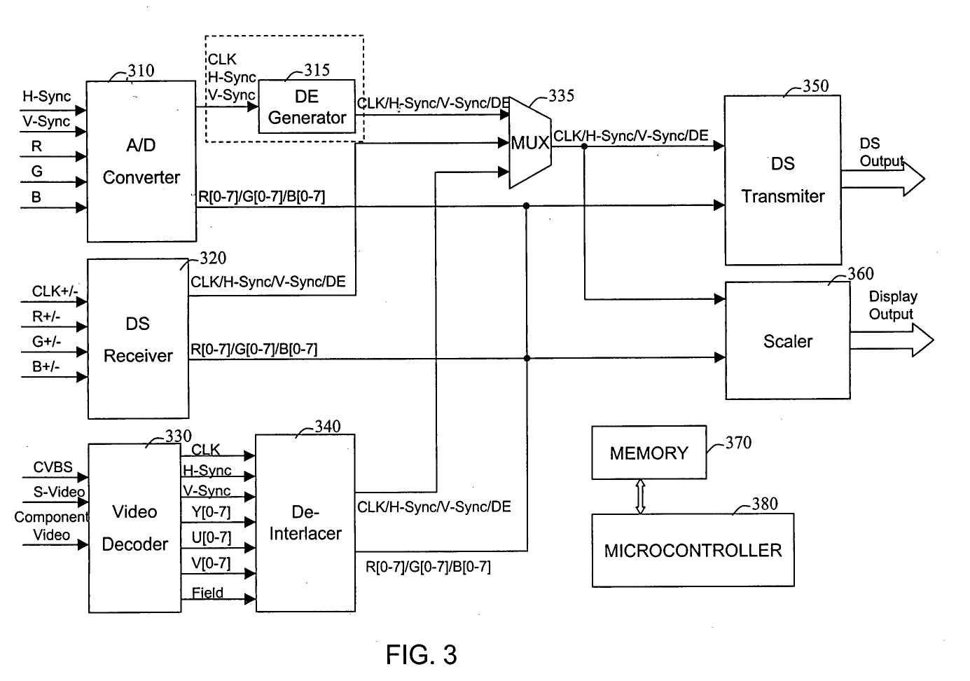

FIG. 3 illustrates a simplified block diagram of a preferred embodiment of a display apparatus in accordance with the present invention. The embodiment comprises an A/D converter 310, a DS receiver 320, and a video decoder 330 respectively for receiving an analog RGB signal from a computer, a DS signal, and a video signal. A synchronous signal outputted from the A/D converter 310 comprises a pixel clock signal CLK, a horizontal synchronizing signal H-Sync, and a vertical synchronizing signal V-Sync. The synchronous signal is transmitted to a data enable signal generator 315 to generate a data enable signal DE. The synchronous signal and the data enable signal DE are transmitted to an input end of a selection switch 335.

In an embodiment of the present invention, a de-interlacer 340 follows the video decoder 330 to de-interlace the input video. After de-interlaced, the video signal in interlaced format is converted into a video signal in progressive scan format. Moreover, the de-interlacer 340 can converts the color space from a YUV format into an RGB format.

The selection switch 335 selects one of the processed synchronous signals according to the analog RGB signal, the DS signal, and the video signal, and outputs the selected synchronous signal to a DS transmitter 350 and a scaler 360. The DS transmitter 350 transmits the selected video signal to a display apparatus of a next stage. The scaler 360 selects a corresponding part of the displayed picture needed displaying according to the position of the display apparatus and enlarges to fit a display device (not illustrated) of the display apparatus for display.

As mentioned above, the data enable signal generator 315 may solve the problem that the synchronous signal outputted from the A/D converter 310 does not comprise a data enable signal. In another embodiment, the de-interlacer 340 may improve the display quality and maintain the color space of the transmitted video signal in an RGB format. As aforementioned, each element of the embodiment is controlled by a microcontroller 380 coupled to a memory 370. The memory 370 stores the detailed data of each synchronization timing. For example, when the timing format of the analog RGB signal is determined, the microcontroller 380 reads the corresponding data from the memory 370 and controls the data enable signal generator 315 to generate a data enable signal.

It is clear that the scaler 240 in FIG. 2 is not included in the embodiment of FIG. 3; therefore, the design of the display apparatus is simplified. Moreover, lack of the scaler 240 makes the timing format (including the resolution) of transmitted video signal as the same as that of the original input signal during transmission. In other words, the original input signal having a high resolution would not be compressed during transmission. Lack of the scaler 240 also makes the delay time eliminated so that an artifact of a displayed moving picture may be avoided.

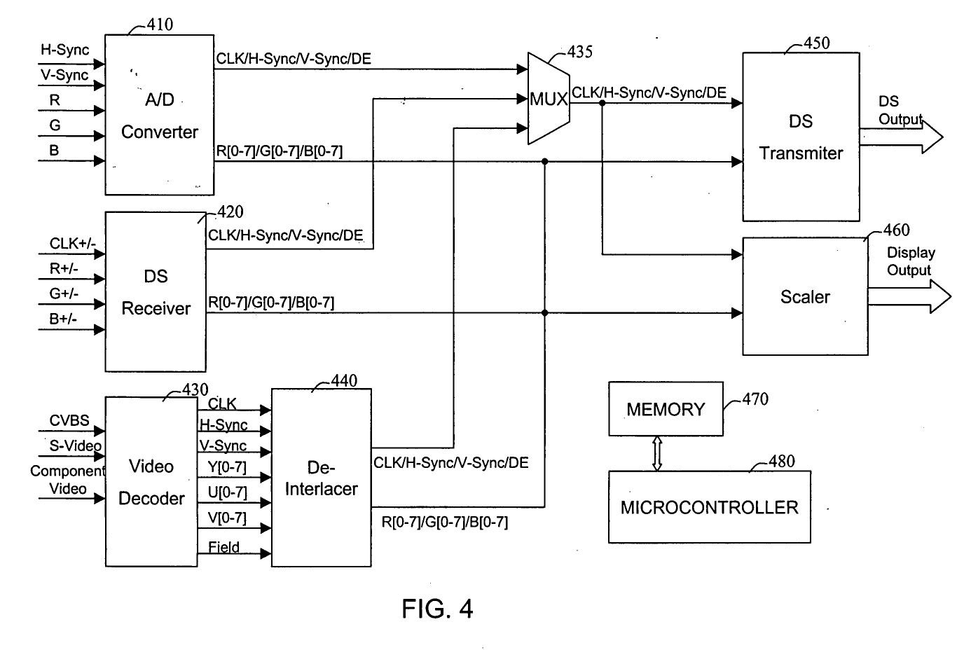

Recently, some providers sell A/D converters capable of generating a data enable signal, such as TDA8754 of Philips or THC7216 of THinc. The block diagram illustrated in FIG. 3 may be simplified to that illustrated in FIG. 4 if such A/D converters are applied. In contrast with the embodiment in FIG. 3, the embodiment in FIG. 4 does not include the data enable signal generator 315. That is because the A/D converter 410 is able to generate a data enable signal itself. The rest elements in FIG. 4 are similar to those in FIG. 3.

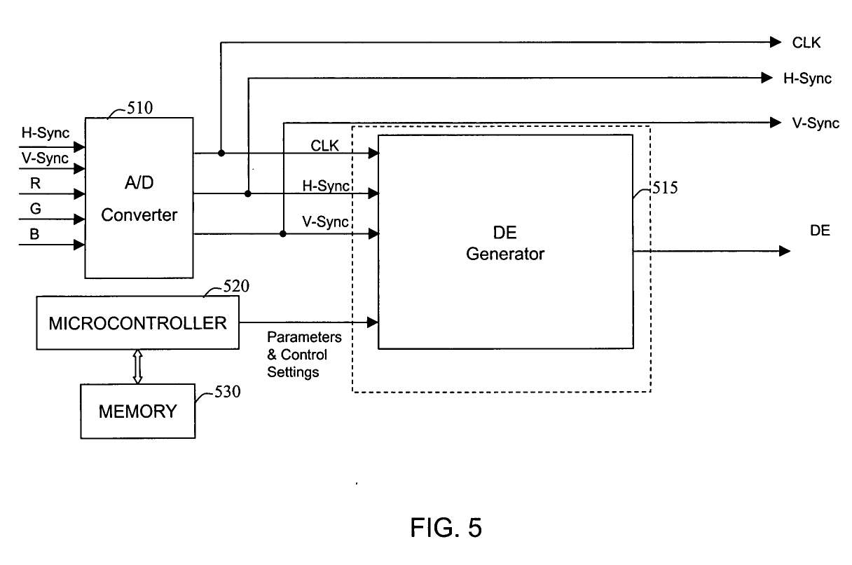

Referring back to FIG. 3, the data enable signal generator 315 follows the A/D converter 310. The synchronous signal processed and outputted by the A/D converter 310 is transmitted to the data enable signal generator 315 to generate the data enable signal DE. The detailed diagram is illustrated in FIG. 5.

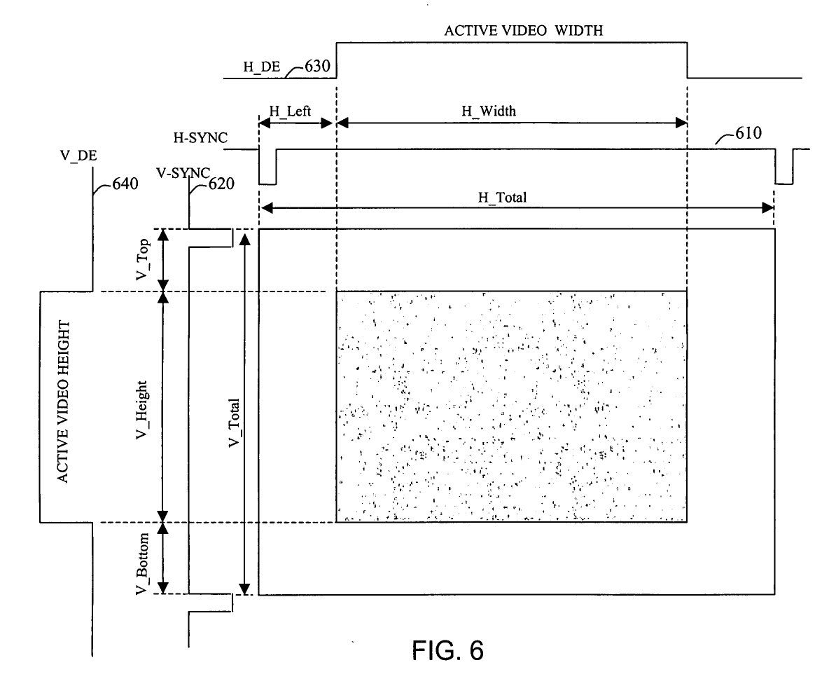

As illustrated in FIG. 5, the data enable signal generator 515 receives a (pixel) clock signal CLK, a horizontal synchronizing signal H-Sync, and a vertical synchronizing signal V-Sync outputted from the A/D converter 510 in order to generate the data enable signal DE. The microprocessor 520 is coupled to the data enable signal generator 515 and a memory 530. The memory 530 stores the parameters associated with all synchronization timings. The microprocessor 520 retrieves the particular parameters, corresponding to the synchronization timing outputted from the A/D converter 510, from the memory 530 in order to control and set the data enable signal generator 515. The data enable signal generator 515 generates the data enable signal DE according to the particular parameters, the clock signal CLK, the horizontal synchronizing signal H-Sync, and the vertical synchronizing signal V-Sync. In practice, the data enable signal generator 515 may be implemented with a FPGA or a synchronization counter, such as a 74F269 chip. FIGS. 6, 7 and 8 show how the data enable signal generator 515 generates the data enable signal DE in detail. Those skilled in the art may realize the generation of the data enable signal with reference to the drawings.

FIG. 6 shows a diagram of the synchronous signal, wherein numeral 610 denotes a horizontal synchronizing signal H_SYNC which represents a line period of a corresponding video signal, numeral 620 denotes a vertical synchronizing signal V_SYNC which represents a frame period of a corresponding video signal, numeral 630 denotes a horizontal data enable signal H_DE which represents a horizontal active video of a corresponding video signal, and numeral 640 denotes a vertical data enable signal V_DE which represents a vertical active lines of a corresponding video signal. The period of the horizontal synchronizing signal 610 refers to the number of the horizontal total cycles (H_Total) and the unit is “clock.” The horizontal data enable signal 630 lags behind the horizontal synchronizing signal 610 for H_Left cycles and actives for H_Width cycles and the units of both H_Left and H_Width are “clock.” The period of the vertical synchronizing signal 620 is denoted as V_Total and the unit is “scanning line.” The vertical data enable signal 640 lags behind the vertical synchronizing signal 620 for V_Top scanning lines and actives for V_Height scanning lines.

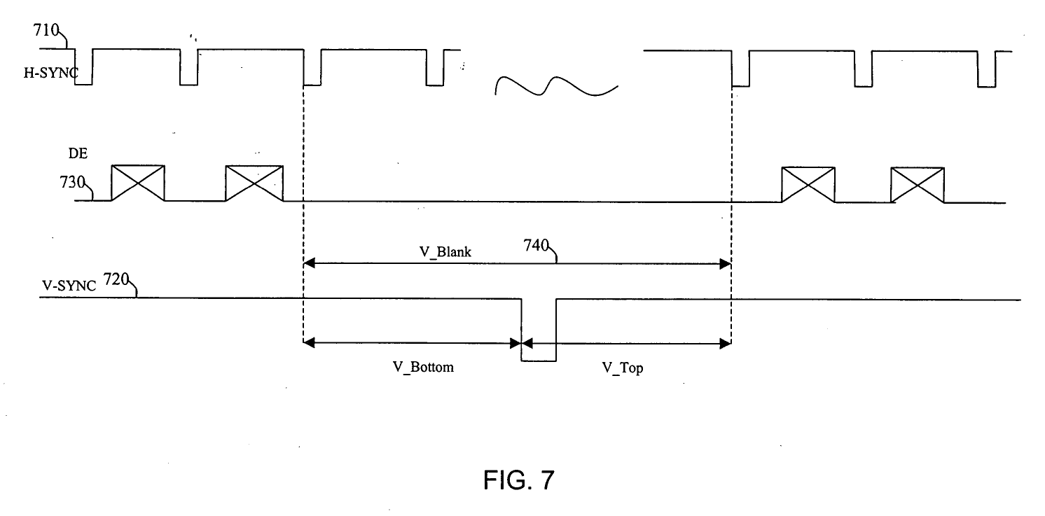

In an embodiment of the present invention, the vertical data enable signal 640 is embedded in the horizontal data enable signal 630, and a data enable signal DE substitutes for it. To attain this object, please refer to FIG. 7, wherein numeral 710 denotes the horizontal synchronizing signal H-SYNC, numeral 720 denotes the vertical synchronizing signal V-SYNC, and numeral 730 denotes the data enable signal DE. The vertical data enable signal 640 being embedded in the horizontal data enable signal 630 means that the data enable signal 730 is blocked between a front porch and a back porch of the vertical synchronization signal 720, i.e., the data enable signal 730 keeps low during the period V_Blank denoted as 740. The data enable signal 730 hence carries the information of the vertical data enable and horizontal data enable. The data enable signal 730 is the aforementioned data enable signal DE disclosed in the embodiment of the present invention. The memory 530 in FIG. 5 stores all parameters of the synchronization timings for display, such as H_Total, V_Total, H_Left, H_Width, V_Top, V_Height, and so on.

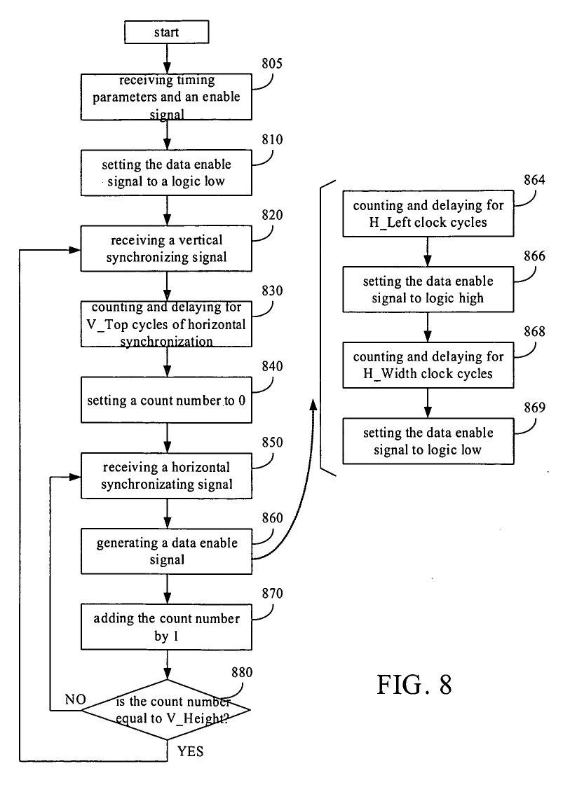

FIG. 8 shows a flow chart illustrating how a data enable signal generator generates a data enable signal in accordance with the present invention. In step 805, receiving timing parameters and an enabling signal from a microprocessor is executed to enable a data enable signal. In step 810, setting the data enable signal to logic low is then executed. In step 820, receiving a vertical synchronizing signal V_SYNC is executed. In step 830, counting and delaying for V_Top cycles of horizontal synchronization is executed. In step 840, setting a count number to 0 is executed. In steps 850 and 860, receiving the horizontal synchronizing signal and generating the data enable signal are executed. In step 870, adding the count number by 1 is executed. In step 880, determining whether the count number is equal to the vertical height V_Height. If yes, the method returns to step 820 to re-receive the vertical synchronizing signal V_SYNC. If not, the method returns to step 850 to receive a next horizontal synchronizing signal.

Step 860 further comprises the following steps. In step 864, counting and delaying for H_Left clock cycles is executed. In step 866, setting the data enable signal to logic high is executed. In step 868, counting and delaying for H_Width clock cycles is executed. In step 869, setting the data enable signal to logic low is executed.

The technology disclosed in the embodiments of the present invention, especially the technology that a differential digital signal is transmitted to a display apparatus of a next stage, may be applied to the display apparatuses of a video wall. The differential digital signaling used in the present invention does not limit to TMDS only. LVDS is also applicable. The spirit of the present invention is to generate a data enable signal for an A/D converter without the ability to generate a data enable signal.

In conclusion, the characteristics of the present invention at least include: providing a data enable signal generator to generate a data enable signal for a differential digital signal transmitter to transmit a differential digital signal if an A/D converter does not provide the data enable signal; providing a data enable signal for a differential digital signal transmitter to transmit a differential digital signal directly if an A/D converter already provides the data enable signal; and providing a de-interlacer to improve the display quality and to maintain the color space of a transmitted video signal in an RGB format during transmission.

With the aforementioned characteristics, the circuitry according to the spirit of the present invention can be simplified compared to that of the prior art. The advantages of the present invention at least include: simplifying the circuitry of a display apparatus so the complexity of design is decreased; maintaining the timing format of an original input signal having any resolution during transmission, i.e., maintaining a high resolution in all display apparatuses; and reducing a delay time due to an additional scaler so that an artifact is hence avoided.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A display apparatus adapted for a video wall, comprising:
an A/D converter for receiving an analog RGB signal and for outputting a first display signal and a first synchronous signal;
a differential digital signal receiver for receiving a differential digital signal and for outputting a second display signal and a second synchronous signal;
a data enable signal generator, connected to the A/D converter, for receiving the first synchronous signal and for outputting a third synchronous signal having a data enable signal;
a selection switch, having an input end connected to the data enable signal generator and the differential digital signal receiver, for selecting one of the second synchronous signal and the third synchronous signal and for outputting a fourth synchronous signal;
a differential digital signal transmitter for transmitting the fourth synchronous signal and for selectively transmitting one of the first display signal and the second display signal; and
a scaler for receiving the fourth synchronous signal and for selectively receiving one of the first display signal and the second display signal as a basis for a picture displayed on the display apparatus.

2. The display apparatus as claimed in claim 1, further comprising a video decoder for receiving a video signal and for outputting a third display signal and a fifth synchronous signal, wherein the fifth synchronous signal is transmitted to the selection switch, the selection switch outputs the fourth synchronous signal according to one of the second synchronous signal, the third synchronous signal and the fifth synchronous signal, the differential digital signal transmitter transmits the fourth synchronous signal and selectively transmits one of the first display signal, the second display signal and the third display signal, and, the scaler receives the fourth synchronous signal and selectively receives one of the first display signal, the second display signal and the third display signal as the basis for the picture displayed on the display apparatus.

3. The display apparatus as claimed in claim 1, further comprising:
a video decoder for receiving a video signal and for outputting a digitized video signal; and
a de-interlacer, connected to the video decoder, for receiving the digitized video signal, and for converting from the digitized video signal into a fourth display signal and a sixth synchronous signal, wherein the sixth synchronous signal is transmitted to the selection switch, the selection switch outputs the fourth synchronous signal according to one of the second synchronous signal, the third synchronous signal and the sixth synchronous signal, the differential digital signal transmitter transmits the fourth synchronous signal and selectively transmits one of the first display signal, the second display signal and the fourth display signal, and the scaler receives the fourth synchronous signal and selectively receives one of the first display signal, the second display signal and the fourth display signal as the basis for the picture displayed on the display apparatus.

4. The display apparatus as claimed in claim 3, wherein the de-interlacer converts from the digitized video signal in a first color space into the fourth display signal in a second color space.

5. The display apparatus as claimed in claim 4, wherein the digitized video signal in the first color space is an interlaced video signal and the fourth display signal in the second color space is a progressive scan video signal.

6. The display apparatus as claimed in claim 4, wherein the first color space is YUV.

7. The display apparatus as claimed in claim 4, wherein the second color space is RGB.

8. The display apparatus as claimed in claim 1, further comprising a microcontroller, coupled to the data enable signal generator, for receiving the analog RGB signal and for controlling the data enable signal generator to generate the data enable signal according to a timing format of the analog RGB signal.

9. The display apparatus as claimed in claim 8, further comprising a memory coupled to the microcontroller, wherein after the microcontroller receives the analog RGB signal, the microcontroller determines the timing format of the analog RGB signal according to a data stored in the memory and controls the data enable signal generator to generate the data enable signal according to a plurality of timing setting parameters corresponding to the determined timing format stored in the memory.

10. The display apparatus as claimed in claim 1, wherein the differential digital signal is a transition minimized differential signaling (TMDS) signal.

11. The display apparatus as claimed in claim 1, wherein the differential digital signal is a low voltage differential signaling (LVDS) signal.

12. A display apparatus adapted for a video wall, comprising:
an A/D converter for receiving an analog RGB signal and for outputting a first display signal and a first synchronous signal having a data enable signal;
a differential digital signal receiver for receiving a differential digital signal and for outputting a second display signal and a second synchronous signal;
a selection switch, having an input end electrically connected to the A/D converter and the differential digital signal receiver, for selecting one of the first synchronous signal and the second synchronous signal and for outputting a third synchronous signal;
a differential digital signal transmitter for transmitting the third synchronous signal and for selectively transmitting one of the first display signal and the second display signal; and
a scaler for receiving the third synchronous signal and for selectively receiving one of the first display signal and the second display signal as a basis for a picture displayed on the display apparatus.

13. The display apparatus as claimed in claim 12, further comprising a video decoder for receiving a video signal and for outputting a third display signal and a fourth synchronous signal, wherein the fourth synchronous signal is transmitted to the selection switch, the selection switch outputs the third synchronous signal according to one of the first synchronous signal, the second synchronous signal, and the fourth synchronous signal, the differential digital signal transmitter transmits the third synchronous signal and selectively transmits one of the first display signal, the second display signal and the third display signal, and the scaler receives the third synchronous signal and selectively receives one of the first display signal, the second display signal and the third display signal as the basis for the picture displayed on the display apparatus.

14. The display apparatus as claimed in claim 12, further comprising:
a video decoder for receiving a video signal and for outputting a digitized video signal; and
a de-interlacer, connected to the video decoder, for receiving the digitized video signal, and for converting from the digitized video signal into a fourth display signal and a fifth synchronous signal, wherein the fifth synchronous signal is transmitted to the selection switch, the selection switch outputs the third synchronous signal according to one of the first synchronous signal, the second synchronous signal, and the fifth synchronous signal, the differential digital signal transmitter transmits the third synchronous signal and selectively transmits one of the first display signal, the second display signal and the fourth display signal, and the scaler receives the third synchronous signal and selectively receives one of the first display signal, the second display signal and the fourth display signal as the basis for the picture displayed on the display apparatus.

15. The display apparatus as claimed in claim 14, wherein the de-interlacer converts from the digitized video signal in a first color space into the fourth display signal in a second color space.

16. The display apparatus as claimed in claim 15, wherein the digitized video signal in the first color space is an interlaced video signal and the fourth display signal in the second color space is a progressive scan video signal.

17. The display apparatus as claimed in claim 15, wherein the first color space is YUV.

18. The display apparatus as claimed in claim 15, wherein the second color space is RGB.

19. The display apparatus as claimed in claim 12, further comprising a microcontroller, coupled to the AID converter, for receiving the analog RGB signal and for controlling the A/D converter to generate the data enable signal according to a timing format of the analog RGB signal.

20. The display apparatus as claimed in claim 19, further comprising a memory coupled to the microcontroller, wherein after the microcontroller receives the analog RGB signal, the microcontroller determines the timing format of the analog RGB signal according to a data stored in the memory and controls the A/D converter to generate the data enable signal according to a plurality of timing setting parameters corresponding to the determined timing format stored in the memory.

21. The display apparatus as claimed in claim 12, wherein the differential digital signal is a TMDS signal.

22. The display apparatus as claimed in claim 12, wherein the differential digital signal is an LVDS signal.

23. A video wall having a plurality of display apparatuses, the plurality of display apparatuses being connected in series, each of the display apparatuses comprising a differential digital signal receiver and a differential digital signal transmitter, the differential digital signal receiver being configured to receive a differential digital signal transmitted by a display apparatus in a previous stage, the differential digital signal transmitter being configured to transmit the differential digital signal to a display apparatus in a next stage, a display apparatus in a first stage of the plurality of display apparatuses further comprising:
an A/D converter for receiving an analog RGB signal and for outputting a first display signal and a first synchronous signal;
a data enable signal generator, connected to the A/D converter, for receiving the first synchronous signal and for outputting a second synchronous signal having a data enable signal;
a selection switch, having an input end electrically connected to the data enable signal generator and the differential digital signal receiver of the display apparatus in the first stage, for selecting one of the second synchronous signal and a synchronous signal of the differential digital signal received from the differential digital signal receiver and for outputting a third synchronous signal, the differential digital signal transmitter of the display apparatus in the first stage being connected to an output end of the selection switch to transmit the third synchronous signal and to selectively transmit one of the first display signal and a display signal of the differential digital signal received from the differential digital signal receiver of the display apparatus in the first stage to the display apparatus of the next stage; and
a scaler for receiving the third synchronous signal and for selectively receiving one of the first display signal and the differential digital signal received from the differential digital signal receiver of the display apparatus in the first stage as a basis for a picture displayed on the display apparatus in the first stage.

24. The video wall as claimed in claim 23, the display apparatus in the first stage of the plurality of display apparatuses further comprising a video decoder for receiving a video signal, and for outputting a second display signal and a fourth synchronous signal, wherein the fourth synchronous signal is transmitted to the selection switch, and the selection switch outputs the third synchronous signal according to one of the second synchronous signal, the synchronous signal of the differential digital signal received by the differential digital signal receiver of the display apparatus in the first stage, and the fourth synchronous signal.

25. The video wall as claimed in claim 23, the display apparatus in the first stage of the plurality of display apparatuses further comprising:
a video decoder for receiving a video signal and for outputting a digitized video signal; and
a de-interlacer, connected to the video decoder, for receiving the digitized video signal, and for converting from the digitized video signal into a third display signal and a fifth synchronous signal, wherein the fifth synchronous signal is transmitted to the selection switch, and the selection switch outputs the third synchronous signal according to one of the second synchronous signal, the synchronous signal of the differential digital signal received from the differential digital signal receiver of the display apparatus in the first stage, and the fifth synchronous signal.

26. The video wall as claimed in claim 25, wherein the de-interlacer converts from the digitized video signal in a first color space into the third display signal in a second color space.

27. The video wall as claimed in claim 26, wherein the digitized video signal in the first color space is an interlaced video signal and the third display signal in the second color space is a progressive scan video signal.

28. The video wall as claimed in claim 26, wherein the first color space is YUV.

29. The video wall as claimed in claim 26, wherein the second color space is RGB.

30. The video wall as claimed in claim 23, the display apparatus in the first stage of the plurality of display apparatuses further comprising a microcontroller, coupled to the data enable signal generator, for receiving the analog RGB signal and for controlling the data enable signal generator to generate the data enable signal according to a timing format of the analog RGB signal.

31. The video wall as claimed in claim 30, the display apparatus in the first stage of the plurality of display apparatuses further comprising a memory coupled to the microcontroller, wherein after the microcontroller receives the analog RGB signal, the microcontroller determines the timing format of the analog RGB signal according to a data stored in the memory and controls the data enable signal generator to generate the data enable signal according to a plurality of timing setting parameters corresponding to the determined timing format stored in the memory.

32. The video wall as claimed in claim 23, wherein the differential digital signal is a TMDS signal.

33. The video wall as claimed in claim 23, wherein the differential digital signal is an LVDS signal.

34. A video wall having a plurality of display apparatuses, the plurality of display apparatuses being connected in series, each of the display apparatuses comprising a differential digital signal receiver and a differential digital signal transmitter, the differential digital signal receiver being configured to receive a differential digital signal transmitted by a display apparatus in a previous stage, the differential digital signal transmitter being configured to transmit the differential digital signal to a display apparatus in a next stage, a display apparatus in a first stage of the display apparatuses further comprising:
an A/D converter for receiving an analog RGB signal and for outputting a first synchronous signal having a data enable signal and a first display signal;
a selection switch, having an input end electrically connected to the A/D converter and the differential digital signal receiver of the display apparatus in the first stage, for selecting one of the first synchronous signal and a synchronous signal of the differential digital signal received from the differential digital signal receiver and for outputting a second synchronous signal, the differential digital signal transmitter of the display apparatus in the first stage being connected to an output end of the selection switch to transmit the second synchronous signal and to selectively transmit one of the first display signal and a display signal of the differential digital signal received from the differential digital receiver of the display apparatus in the first stage to the display apparatus in the next stage; and
a scaler for receiving the second synchronous signal and for selectively receiving one of the first display signal and the display signal of the differential digital signal received from the differential digital receiver of the display apparatus in the first stage as a basis for a picture displayed on the display apparatus in the first stage.

35. The video wall as claimed in claim 34, the display apparatus in the first stage of the plurality of display apparatuses further comprising a video decoder for receiving a video signal and for outputting a second display signal and a third synchronous signal, wherein the third synchronous signal is transmitted to the selection switch and the selection switch outputs the second synchronous signal according to one of the first synchronous signal, the synchronous signal of the differential digital signal received from the differential digital signal receiver of the display apparatus in the first stage, and the third synchronous signal.

36. The video wall as claimed in claim 34, the display apparatus in the first stage of the plurality of display apparatuses further comprising:
a video decoder for receiving a video signal and for outputting a digitized video signal; and
a de-interlacer, connected to the video decoder, for receiving the digitized video signal, and for converting from the digitized video signal into a third display signal and a fourth synchronous signal, wherein the fourth synchronous signal is transmitted to the selection switch, and the selection switch outputs the second synchronous signal according to one of the first synchronous signal, the synchronous signal of the differential digital signal received from the differential digital signal receiver of the display apparatus in the first stage, and the fourth synchronous signal.

37. The video wall as claimed in claim 36, wherein the de-interlacer converts from the digitized video signal in a first color space into the third display signal in a second color space.

38. The video wall as claimed in claim 37, wherein the digitized video signal in the first color space is an interlaced video signal and the third display signal in the second color space is a progressive scan video signal.

39. The video wall as claimed in claim 37, wherein the first color space is YUV.

40. The video wall as claimed in claim 37, wherein the second color space is RGB.

41. The video wall as claimed in claim 34, the display apparatus in the first stage of the plurality of display apparatuses further comprising a microcontroller, coupled to the A/D converter, for receiving the analog RGB signal and for controlling the A/D converter to generate the data enable signal according to a timing format of the analog RGB signal.

42. The video wall as claimed in claim 41, the display apparatus in the first stage of the plurality of display apparatuses further comprising a memory coupled to the microcontroller, wherein after the microcontroller receives the analog RGB signal, the microcontroller determines the timing format of the analog RGB signal according to a data stored in the memory and controls the A/D converter to generate the data enable signal according to a plurality of timing setting parameters corresponding to the determined timing format stored in the memory.

43. The video wall as claimed in claim 34, wherein the differential digital signal is a TMDS signal.

44. The video wall as claimed in claim 34, wherein the differential digital signal is an LVDS signal.

45. A video conversion apparatus adapted for A/D converting and transmitting an analog video to an external display apparatus via a differential digital signal transmission, comprising:
an A/D converter for receiving an analog RGB signal and for outputting a first display signal and a first synchronous signal;
a data enable generator, connected to the A/D converter, for receiving the first synchronous signal and for outputting a second synchronous signal having a data enable signal;
a differential digital signal transmitter for transmitting the second synchronous signal and the first display signal;

46. The video conversion apparatus as claimed in claim 45, further comprising a microcontroller, coupled to the data enable signal generator, for receiving the analog RGB signal and for controlling the data enable signal generator to generate the data enable signal according to a timing format of the analog RGB signal.

47. The video conversion apparatus as claimed in claim 46, further comprising a memory coupled to the microcontroller, wherein after the microcontroller receives the analog RGB signal, the microcontroller determines the timing format of the analog RGB signal according to a data stored in the memory and controls the data enable signal generator to generate the data enable signal according to a plurality of timing setting parameters corresponding to the determined timing format stored in the memory.
